(19) United States
(12) Patent Application Publication
(10) Pub. No.: US 2007/0151379 A1
(43) Pub. Date: Jul. 5, 2007

(54) Backlash reducer for gearbox

(76) Inventor: Richard W. Lukanen JR., Alexandria, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/313,063

(22) Filed: Dec. 20, 2005

(51) Int. Cl. F16H 55/18

(52) U.S. Cl. 74/409

(57) ABSTRACT

A backlash reducing apparatus for a gearbox, the gearbox having a hollow bore and a shaft in the hollow bore, with the hollow bore having a counter-bore at each end includes: a first pair of tapered, interlocking rings engaging the shaft within the hollow bore at one end of the hollow bore; a second pair of tapered, interlocking rings engaging the shaft within the hollow bore at the opposite end of the hollow bore; and a fastener engaging the shaft and applying axial pressure to the first and second pairs of tapered, interlocking rings to thereby force the first and second pairs of tapered, interlocking rings against the shaft and the hollow bore. A method for reducing backlash in a gearbox, the gearbox having a hollow bore and a shaft in the hollow bore, consists of: engaging a first pair of tapered, interlocking rings against the shaft within the hollow bore at one end of the hollow bore; engaging a second pair of tapered, interlocking rings against the shaft within the hollow bore at the other end of the hollow bore; and applying axial pressure to the first and second pairs of tapered, interlocking rings to thereby force the first and second pairs of tapered, interlocking rings against the shaft and the hollow bore.

### BACKGROUND OF THE INVENTION

The present application is related to a backlash reducing mechanism for a gearbox or the like, and in particular to a backlash reducer that incorporates opposed pairs of interlocking, tapered rings at opposite ends of the gearbox hollow output shaft.

Mechanical loss motion (resulting from backlash) is of concern in servo drive line components; positioning errors, changes to systems dynamics, and mechanical component failures are all attributed to system backlash. To minimize loss motion designers look for ways to reduce or completely eliminate the backlash in each component in the system. This can affect the economy of the design, or introduce added complexity that may make implementation impossible.

FIG. 1 is a schematic of a hollow bore output gearbox 10 with a housing 12. This particular drawing shows a worm design for clarity. An output gear 16 incorporates a hollow bore 22 through hub 14. A periphery of gear teeth 17 engage the worm 18 which is driven via the input shaft 20. The worm and gear are enclosed within the housing 12. In operation, a driving power source (not shown) is connected to the input shaft 20 to effect motion and power to the driven machine (not shown) coupled to the hollow output shaft 14. Connections to the driving power source and driven machine are generally effected through conventional means, as by direct coupling to shafts, spur gearing, belt, chain drives, and the like.

Loss motion often occurs where a shaft (not shown) goes thru such a hollow bore gearbox 10. Typically, the shaft is held tightly in place within the hollow bore or hub 22 by a key (not shown). In such a system, a simple fit of the shaft, key and hub 22 is often the major factor determining the amount of loss motion in the system. In addition to loss motion, it is important to consider the failure modes of the connection. Because keyed connections are mechanically dimensioned for slip fit assembly they will fail from wear when undergoing reciprocating motions. The constant sliding of these surfaces can also result in fretting corrosion that leads to cracking of metal surfaces and ultimately a broken shaft/hub/key system. Key connections can also fatigue fail and break due to cyclic torque reversals on the key.

Technologies exist to eliminate the keys and their failings. The currently accepted design used by many gearbox manufactures implements a means to squeeze the hollow gearbox hub down over the shaft. Although this concept works well, it comes with complexity and high cost.

Internal locking devices such as the Ringfeder GSA-1000 locking ring elements (Ringfeder Corporation, 165 Carver Ave., Westwood, N.J. 07675) (FIGS. 3 and 4) have been used for some time to frictionally connect a shaft to a hub, but not within a gearbox hollow bore. Such locking rings are disclosed in U.S. Pat. Nos. 3,957,381 and 4,025,213, herein incorporated by reference. Locking rings are simply a nested pair of tapered rings. The taper angle is typically around 16.7 degrees. The outer ring is tapered on its inside and the inner ring is tapered on its outside. An axial force is applied to the tapered rings (squeezing the rings together) which results in inward and outward radial forces on the shaft and hub creating a backlash free connection. It is the engineer's job, however, to devise means to place the nested rings inside the hub where the shaft will be located. He will also need to incorporate a means to apply the axial force on the tapered rings so they develop radial holding forces to the shaft and hub. Strength of the shaft and hub materials must also be considered. The forces (or pressure) on the shaft and hub will be very high because it is merely friction between the parts that transmits the power between the hub and shaft. The advantage of this design is that the rings are very low profile and can fit into hubs not much larger in diameter than the shaft.

Rather than use locking rings, the industry standard for gearboxes is to use a shrink disk. A shrink disk 30 (FIG. 2) is a device that squeezes a hollow hub 22 down on to a thru shaft 20 outside the hollow bore of the gearbox. Very high pressures are developed to squeeze the hub 22 down on the shaft 20. Shrink disks 30 have numerous screws 32 located around the periphery of the device. These screws are used to create the radial forces required to squeeze down on the hub. The assembly procedure can be fairly elaborate; each screw must be tightened evenly to the specified torque. One must follow a specific pattern to help draw the shrink disk down on the hub evenly all around the outside of the hub. The straight forward simplicity of engineering the shrink disk design is likely why the industry standardized on that device. They didn't have to worry about space limitations, or bursting the hub from the inside. These devices are quite costly. The shrink disks are also too large, and assembly procedure is complex enough that assembly time would be increased. Although the shrink disks have advantages they do not allow the engineer to optimize the application as was possible, in other devices, with the locking elements.

There is a need for an improved backlash reducer for gearboxes and the like that overcomes the above problems using locking elements within the hollow bore of a gearbox.

### SUMMARY OF THE INVENTION

A backlash reducing apparatus for a gearbox, the gearbox having a hollow bore and a shaft therethrough, the hollow bore having a counter-bore at each end thereof, the apparatus comprising:

(a) a first pair of tapered, interlocking rings engaging the shaft within the hollow bore at one end of the hollow bore;

(b) a second pair of tapered, interlocking rings engaging the shaft within the hollow bore at the opposite end of the hollow bore; and

(c) a fastener engaging the shaft and applying axial pressure to the first and second pairs of tapered, interlocking rings to thereby force the first and second pairs of tapered, interlocking rings against the shaft and the hollow bore.

A method for reducing backlash in a gearbox, the gearbox having a hollow bore and a shaft therethrough, comprising the steps of:

(a) engaging a first pair of tapered, interlocking rings against the shaft within the hollow bore at one end of the hollow bore;

(b) engaging a second pair of tapered, interlocking rings against the shaft within the hollow bore at the other end of the hollow bore; and

(c) applying axial pressure to the first and second pairs of tapered, interlocking rings to thereby force the first and second pairs of tapered, interlocking rings against the shaft and the hollow bore.

The present invention includes placing locking elements into the hollow bore of a gearbox. The ratio of hub outside diameter to shaft diameter is such that the hub wall thickness may be very thin. This is a very clean, simple, and low cost design that has been needed for continuous motion packaging machinery and other industries.

A simple counter bore is made at each end of the hollow bore where the locking elements will be installed. Two simple rings are machined so that the bolt's axial clamping force is applied to the locking rings.

A principal object and advantage of the present invention is that with locking elements installed on both ends of the hollow bore the design inherently centers the thru shaft so that runout (wobble) is virtually eliminated from the design.

Another principal object and advantage of the present invention is that the concentric tapered locking rings located on both ends of the hollow bore within the hollow bore make the runout of the shaft independent of the assembly operations. This is true since the tapered locking rings always center themselves exactly under any bolt loading condition.

Another principal object and advantage of the present invention is a specially designed key. A key is still used so it is impossible for the shaft to slip in extreme overload jam conditions. The keyseat is end milled into the shaft (in contrast to a sled runner type) so that it is not free to move around causing difficult assembly and disassembly.

Another principal object and advantage of the present invention is that it is also more compact than a shrink disk design. The space savings is often very important when designing machines where factory floor space demands a small machine.

Another principal object and advantage of the present invention is that both ends of the gearbox are sealed, keeping out the environment.

Another principal object and advantage of the present invention is that the low profile and uncomplicated design is suitable for dirty environments since it is easily cleaned—not a lot of crevices to collect debris.

Another object and advantage of the present invention is that the key is completely sealed inside the gearbox. This is of added value to ensure the key and shaft do not rust, causing the shaft to stick inside the gearbox.

Another principal object and advantage of the present invention is manufacturing cost savings. This cost savings approaches a factor of 10 over the shrink disk design. The shrink disk cost approaches that of the gearbox. The internal locking design also allows for a shaft tolerance that is less costly to machine than the same shaft if used with the shrink disk design.

### BRIEF DESCRIPTION OF DRAWINGS

FIG. 1 is a schematic cross-section of a gearbox of the prior art.

FIG. 2 is a perspective view of a gearbox with a shrink disk used to squeeze the hub onto a shaft, as in the prior art.

FIG. 3 is a perspective view of a pair of internal locking ring elements of the prior art.

FIG. 4 is a perspective view of another type of internal locking ring elements of the prior art.

FIG. 5 is a perspective view of the present invention.

FIG. 6 is a cross-section taken at approximately the lines 6 of FIG. 5.

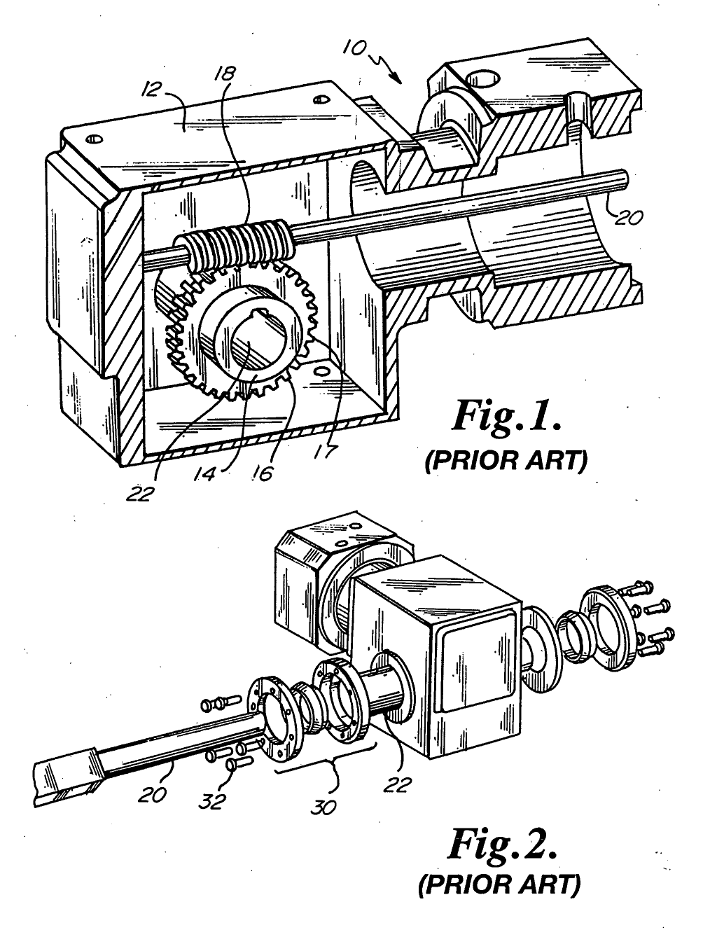

### DETAILED DESCRIPTION OF THE PREFERRED EMBODIMENT

The present invention is generally shown in the Figures as reference numeral 110.

The present invention 110 is a gearbox 110 having a housing 112, an input shaft 120, and an output shaft 114 journalled within a hollow bore 122.

A backlash reducing apparatus 130 comprises a first pair 132 of interlocking rings engaging the shaft 114 within the hollow bore 122 at one end of the hollow bore 122; a second pair 134 of interlocking rings engaging the shaft 114 at the opposite end of the hollow bore 122; and a fastener 136 engaging the shaft 114 and applying axial pressure to the first 132 and second 134 pairs of interlocking rings to thereby force the first 132 and second 134 pairs of interlocking rings against the shaft 114 and hollow bore 122.

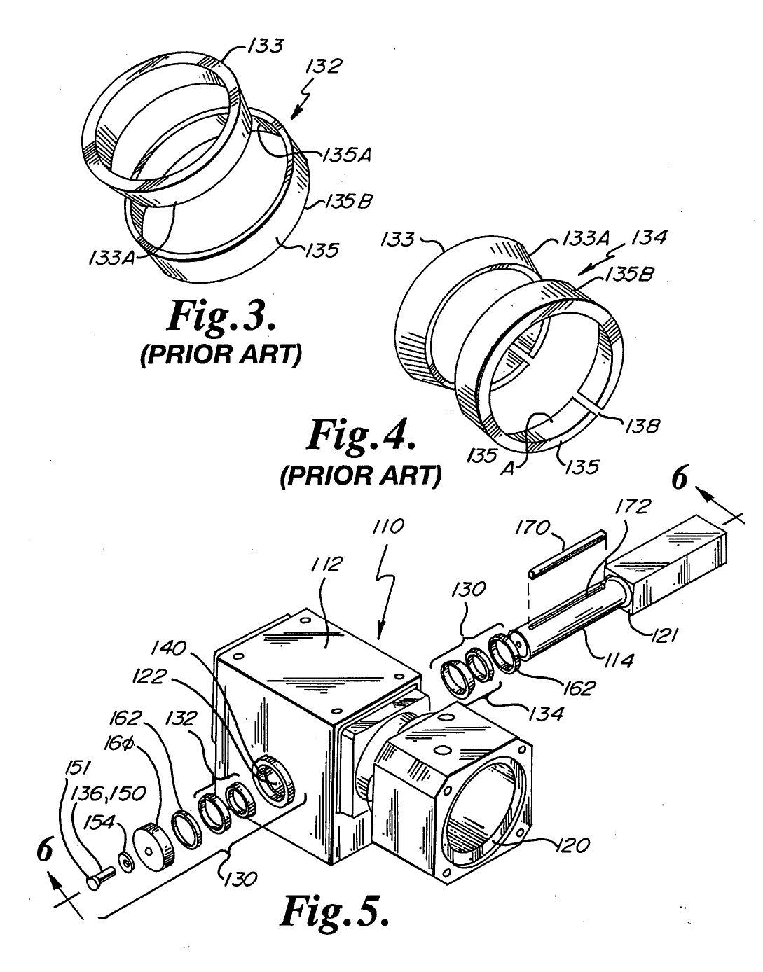

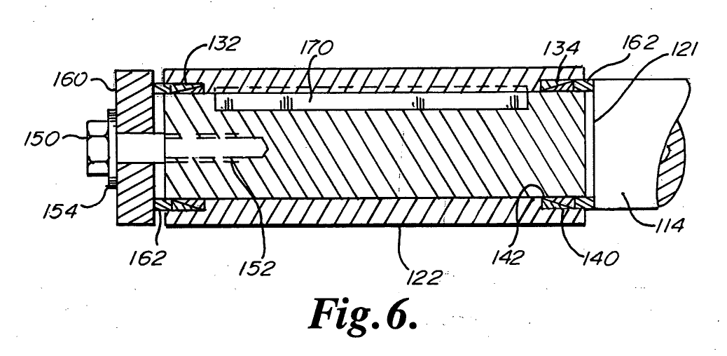

As shown in FIGS. 3 and 4, the pairs 132 and 134 of interlocking rings comprise an inner ring 133 and an outer ring 135. The outer ring 135 is tapered on its inner surface 135A, as shown; and the inner ring 133 is tapered on its outer surface 133A as shown. The tapers of inner ring and outer ring are opposed, so that the rings nest as they are squeezed together. As the rings are squeezed together, the outer surface 135B of the outer ring is pressed forcefully against the hub 122. To optimize the forces applied to the hub, one of the pairs suitably has a slit 138 through its circumference.

Preferably, each of the pairs 132 and 134 of interlocking rings are mounted within a counter-bore or recess 140 within the hollow bore 122 at each end of the hollow bore 122. The counter-bore or recess 140 has a lip or flange 142 against which the pairs of interlocking rings are forced by axial pressure, as is explained below.

A fastener 136 such as a bolt or screw 150 is inserted into a threaded aperture 152 which has been tapped into the shaft 114. Suitably, a washer 154 surrounds the head 151 of the bolt 150.

Preferably, a compression disk 160, sized to substantially match the diameter of the hollow bore 122, is used to force the pairs 132 and 134 against the lip or flange 142. An adapter ring 162 of diameter substantially the same as that of the pairs 132 and 134 is used between the compression disk 160 and the pairs 132 and 134.

Preferably, a key 170 is inserted into a key seat 172 which has been suitably milled into the shaft 114. The key retains the shaft 114 within the hollow bore 122 against slippage during extreme overload jam conditions.

To assemble the apparatus 110, one of the adapter rings 162 is slid onto the shaft 114 so that it butts against a stop 121 on the shaft. Then, the slit nested interlocking rings 134 are slid onto the shaft, making sure that the inner ring goes on first, then the outer ring is slid onto the shaft 114. Next, the optional key 170 is inserted into the key seat 172. The shaft 114 is then slid into the hollow bore 122.

Next, the other pair of interlocking rings 132 is inserted into the counter-bore or recess 140 at the opposite end of the gearbox's hollow bore output 122. When performing this step, the inner ring must go in first, then the outer ring is inserted. The other adapter ring 162, compression disk 160, washer 154, and fastener 150 are then mounted and the fastener is torqued to produce an axial force to the interlocking rings 132 and 134 as they bear against the flanges 142 within the counter-bores 140. This axial force results in inward and outward radial forces on the shaft 114 and hollow bore 122, creating a backlash free connection between the shaft 114 and bore 122.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A backlash reducing apparatus for a gearbox, the gearbox having a hollow bore and a shaft therethrough, the hollow bore having a counter-bore at each end thereof, the apparatus comprising:
(a) a first pair of tapered, interlocking rings engaging the shaft within the hollow bore at one end of the hollow bore;
(b) a second pair of tapered, interlocking rings engaging the shaft within the hollow bore at the opposite end of the hollow bore; and
(c) a fastener engaging the shaft and applying axial pressure to the first and second pairs of tapered, interlocking rings to thereby force the first and second pairs of tapered, interlocking rings against the shaft and the hollow bore.

2. The apparatus of claim 1, further comprising a compression disk between the fastener and the first pair of tapered, interlocking rings.

3. The apparatus of claim 2, further comprising an adapter ring between the compression disk and the first pair of tapered, interlocking rings, the adapter ring being forced by the compression disk against the first pair of tapered, interlocking rings.

4. The apparatus of claim 3, further comprising a second adapter ring between the shaft and the second pair of tapered, interlocking rings, the second adapter ring being forced against the second pair of tapered, interlocking rings by axial forces.

5. The apparatus of claim 4, wherein the first and second pairs of interlocking rings are adapted to rest in the counter-bores at each end of the hollow bore.

6. The apparatus of claim 1, further comprising a key seat milled into the shaft and a key engaging the key seat.

7. The apparatus of claim 1, wherein the fastener further comprises a bolt and washer.

8. The apparatus of claim 1, wherein one of the first and second pair of interlocking rings further comprises an inner ring and an outer ring, each of the inner ring and outer ringing having a slit through the circumference thereof.

9. A gearbox with a backlash reducing apparatus, the gearbox having a hollow bore and a shaft therethrough, the hollow bore having a counter-bore at each end thereof, the apparatus comprising:
(a) a first pair of tapered, interlocking rings engaging the shaft within the hollow bore at one end of the hollow bore;
(b) a second pair of tapered, interlocking rings engaging the shaft within the hollow bore at the opposite end of the hollow bore; and
(c) a fastener engaging the shaft and applying axial pressure to the first and second pairs of tapered, interlocking rings to thereby force the first and second pairs of tapered, interlocking rings against the shaft and the hollow bore.

10. The apparatus of claim 9 further comprising a compression disk between the fastener and the first pair of tapered, interlocking rings.

11. The apparatus of claim 10, further comprising an adapter ring between the compression disk and the first pair of interlocking rings, the adapter ring being forced by the compression disk against the first pair of tapered, interlocking rings.

12. The apparatus of claim 11, further comprising a second adapter ring between the shaft and the second pair of interlocking rings, the second adapter ring being forced against the second pair of tapered, interlocking rings by axial forces.

13. The apparatus of claim 12, wherein the first and second pairs of tapered, interlocking rings are adapted to rest in the counter-bores at each end of the hollow bore.

14. The apparatus of claim 9, further comprising a key seat milled into the shaft and a key engaging the key seat.

15. The apparatus of claim 14, wherein the fastener further comprises a bolt and washer.

16. The apparatus of claim 9, wherein one of the first and second pairs of tapered, interlocking rings further comprises an inner ring and an outer ring, each of the inner ring and outer ringing having a slit through the circumference thereof.

17. A method for reducing backlash in a gearbox, the gearbox having a hollow bore and a shaft therethrough, comprising the steps of:
(a) engaging a first pair of tapered, interlocking rings against the shaft within the hollow bore at one end of the hollow bore;
(b) engaging a second pair of tapered, interlocking rings against the shaft within the hollow bore at the other end of the hollow bore; and
(c) applying axial pressure to the first and second pairs of tapered, interlocking rings to thereby force the first and second pairs of tapered, interlocking rings against the shaft and the hollow bore.

18. A method for reducing backlash in a gearbox, the gearbox having a hollow bore and a shaft therethrough, comprising the steps of:
(a) constructing a counter-bore at each end of the hollow bore;
(b) sliding an adaptor ring onto the shaft, the adaptor ring butting against a stop on the shaft;
(c) sliding a first pair of tapered, interlocking rings onto the shaft;
(d) sliding the shaft into the hollow bore;
(e) inserting a second pair of tapered, interlocking rings into the counter-bore at the other end of the hollow bore;
(f) sliding a second adaptor ring, a compression disk, and a washer onto a fastener;
(g) inserting the fastener into the shaft, with the second pair of interlocking rings bearing against the second adaptor ring; and
(h) tightening the fastener to produce an axial force against the second pair of interlocking rings and the first pair of interlocking rings, the axial force producing inward and outward radial forces on the shaft and the hollow bore.

19. The method of claim 18, wherein the first pair of interlocking rings is slit.

20. The method of claim 19, wherein the shaft contains a key seat milled therein and further comprising the step of inserting a key into the key seat before the shaft is inserted into the hollow bore.
